(19) United States
(12) Patent Application Publication
(10) Pub. No.: US 2026/0242658 A1
(43) Pub. Date: Aug. 20, 2026

(54) SCALE INHIBITOR COMPOSITION AND METHODS OF USING THE SAME FOR TREATING SCALE IN A WELLBORE

(71) Applicant: Saudi Arabian Oil Company, Dhahran (SA)

(72) Inventors: Qiwei Wang, Dhahran (SA); Tawfik Al-Ghamdi, Dammam (SA); Sultan H. Alsubaie, Dhahran (SA)

(21) Appl. No.: 19/058,382

(22) Filed: Feb. 20, 2025

(51) Int. Cl. C09K 8/532; C02F 5/14; C02F 103/10; E21B 37/06

(52) U.S. Cl. CPC C09K 8/532; C02F 5/14; E21B 37/06; C02F 2103/10

(57) ABSTRACT

A method for treating scale deposits. The method including feeding a scale inhibitor composition through a wellbore positioned in a portion of a subterranean formation to contact a scale deposit. The scale inhibitor composition includes a solvent, a scale inhibitor and an additive. The scale inhibitor is present in an amount from 25 wt. % to 75 wt. %, based on a total weight of the scale inhibitor composition, and the additive is present in an amount from 0.1 wt. % to 10 wt. %, based on the total weight of the scale inhibitor composition. The additive includes an amino polycarboxylic acid.

### TECHNICAL FIELD

Embodiments of the disclosure generally relate to scale inhibitor compositions. More specifically, embodiments of this disclosure relate to a scale inhibitor composition and methods of using the same for enhancing scale inhibition in a wellbore.

### BACKGROUND

In the oil and gas industry, inorganic scale deposition is a common problem. It can be deposited all along the water paths from near wellbore, downhole tubular to surface flowline and separation plant. Large sums of money are spent on cleaning and preventative measures to maintain the operation systems in the state of operation and efficiency. The oil industry normally encounters two types of scale formation. First, carbonate scales take place where there is a change in temperature and pressure which result in the release of carbon dioxide from aqueous form to gas form from the flowing fluids. Second, sulfate scales come about where there is a mixture of two or more incompatible fluids, i.e., one or some streams with high sulfate and others with high divalent earth metals (calcium, strontium, barium).

Scale deposits restrict hydrocarbon flow, damage equipment, induce localized corrosion, and also interfere with oil-water separation. Heavy scale deposition can result in complete production shut-down, leading to economic losses. Metal sulfate is one of the most common scale deposits, including barium sulfate (BaSO₄, barite), strontium sulfate (SrSO₄, celestite), and calcium sulfate which can be in three different forms: gypsum (CaSO₄·2H₂O), anhydrite (CaSO₄) and hemihydrate (CaSO₄·½H₂O). The formation of sulfate scales is largely resulted from mixing of incompatible waters, such as one water with high sulfate anions and another water with high divalent cations.

Produced water from a sour gas reservoir has high barium concentration, while the produced water from a deeper sweet gas reservoir in the same field has high sulfate concentration. When the produced fluids are transported separately and then mixed at the sludge catcher of gas separation plant, the commingled fluid (water) becomes supersaturated to sulfate scale. Scaling mass is the maximum amount of barite scale can be formed in the mixed water at the given mixing ratio. Even a small amount of sour produced water mixed with sweet produced water can result in barite scaling, and vice versa. The scaling risk changes with mixing ratio, where the highest degree of supersaturation occurs at 50%:50% mixing, and typically the highest scaling amount is at 80% sweet water and 20% sour water mixture. Unlike calcium carbonate scale which can be dissolved readily with low cost hydrochloric acid, sulfate scales, in particular barite, is hard and tenacious; Once formed, it is difficult to remove.

Use of threshold inhibitor products is the most common practice in oil industry to prevent inorganic scale deposition in production systems. The application dosage of such inhibitors is dependent on their inhibition efficacy in the given system, which is affected by many factors such as water geochemical composition, water quality, system temperature, hydrodynamics, etc.

### SUMMARY

This disclosure creatively provides new methods to substantially improve the inhibitor performance against sulfate scale formation, especially barium sulfate (barite) scale, by using additive such as a polyamino carboxylic acid. Test results demonstrated that a polyamino carboxylic acid, e.g., HEDTA, is surprisingly good at enhance the scale inhibitor performance against sulfate scale, in particular barium sulfate. The inhibition efficiency of phosphate and polyacrylate based inhibitors can be significantly improved by low level of HEDTA in preventing barite scale formation.

HEDTA is widely used as a chelating agent in cosmetic formulations. It has lower cost and much lower environmental impact than the common organic phosphate inhibitors. Therefore, formulating polyamino carboxylic acids such as HEDTA with organophosphorus scale inhibitors will enhance scale treatment efficiency, improve the treatment reliability, reduce inhibitor consumption and treatment cost, and minimize the environment impact by chemical treatment.

The methods disclosed herein are superior in oilfield scaling control to the current practices in:
Effectively preventing sulfate scale deposition;
Less inhibitor consumption;
Low maintenance requirement;
Reduced operation cost;
Lower treatment cost with high inhibitor use efficiency;
Minimize the environment impact by common scale inhibitors.

An aspect of the present disclosure relates to scale inhibitor compositions and methods of using the same. In an aspect, the present disclosure relates to a method. The method includes feeding a scale inhibitor composition to a wellbore positioned in a portion of a subterranean formation to contact a scale deposit. The scale inhibitor composition includes a solvent, a scale inhibitor in an amount from about 25 wt. % to about 75 wt. %, based on a total weight of the scale inhibitor composition, and an additive in an amount from about 0.1 wt. % to about 10 wt. %, based on the total weight of the scale inhibitor composition, wherein the additive comprises an amino polycarboxylic acid.

In another aspect, the present disclosure relates to a method. The method includes feeding a scale inhibitor and an additive comprising an amino polycarboxylic acid to a wellbore positioned in a portion of a subterranean formation to contact a scale deposit, where a total weight ratio of the scale inhibitor to the additive fed to the wellbore is at least 5:1, and where wherein the scale inhibitor comprises a phosphonate-based scale inhibitor, a polymer-based scale inhibitor, or a combination thereof.

In yet another aspect, the present disclosure relates to a scale inhibitor composition. The scale inhibitor composition includes a solvent, a scale inhibitor in an amount from about 25 wt. % to about 75 wt. %, based on a total weight of the scale inhibitor composition, an additive in an amount from about 0.1 wt. % to about 10 wt. %, based on the total weight of the scale inhibitor composition. In some embodiments, the additive includes an amino polycarboxylic acid.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF THE DRAWINGS

FIG. 1 is a schematic drawing of a system that includes a scale inhibitor composition according to an embodiment of the present disclosure.

FIG. 2 is a schematic drawing of a method according to an embodiment of the present disclosure.

FIG. 3 is a laser apparatus configured to measure a change in turbidity of scaling waters according to an embodiment of the present disclosure.

FIG. 4 is a graph of laser turbidity test results with no additive in a first test and with 2 ppm additive in a second test according to an embodiment of the present disclosure.

FIG. 5 is a graph of laser turbidity test results with 10 ppm of a phosphonate-based scale inhibitor and no additive in a first test and 10 ppm of a phosphonate-based scale inhibitor with 2 ppm of an additive in a second test according to an embodiment of the present disclosure.

Like reference numbers and designations in the various drawings indicate like elements.

### DETAILED DESCRIPTION

The present disclosure relates to scale inhibitor compositions and methods of using the same for treating scale deposits in a wellbore. The provided scale inhibitor compositions and methods of using the same provide practical applications and technical advantages that address various problems associated with treating scale deposits, particularly sulfate scale deposits, in the wellbore. For example, one technical issue associated with scale inhibitors, particularly organophosphorus compounds, is that they are expensive and may have environmental impacts. Accordingly, reducing inhibitor consumption is beneficial in lowering operational cost and reducing potential environmental impacts.

Embodiments of the present disclosure address the aforementioned technical issues, in part, by combining an additive that includes an amino polycarboxylic acid with a scale inhibitor to form a scale inhibitor composition. The combination of the amino polycarboxylic acid with the scale inhibitor in the scale inhibitor composition surprisingly and unexpectedly improves scale inhibitor performance in reducing, or otherwise removing, scale deposits in a wellbore relative to the same composition without the amino polycarboxylic acid. The provided scale inhibitor composition provides several benefits. For example, the amino polycarboxylic acid has a lower cost relative and a lower environmental impact relative to scale inhibitors, such as organophosphorus compounds. Additionally, the synergistic effects between the amino polycarboxylic acid and the scale inhibitor allow for less inhibitor consumption for the same scale deposit removal. These advantages lower maintenance and operational costs, while additionally minimizing potential environmental impacts.

In some embodiments, the present disclosure provides a scale inhibitor composition. The scale inhibitor composition includes a solvent, a scale inhibitor, and an additive that includes an amino polycarboxylic acid. In some embodiments, the amino polycarboxylic acid is a phosphorous-free amino poly carboxylic acid. In some embodiments, the amino polycarboxylic acid is hydroxyethyl ethylene diamine tetraacetic acid (HEDTA).

In some embodiments, the solvent includes water, an organic solvent, or a combination thereof. In some embodiments, the organic solvent includes methanol, acetone, monoethylene glycol, triethylene glycol, or a combination thereof. In some embodiments, the solvent is present in the scale inhibitor composition in an amount from about 25 wt. % to about 75 wt. %, based on a total weight of the scale inhibitor composition. In some embodiments, the solvent is present in the scale inhibitor composition in an amount of at least about 25 wt. % (e.g., at least about 26 wt. %, at least about 27 wt. %, at least about 28 wt. %, at least about 29 wt. %, at least about 30 wt. %, at least about 35 wt. %, at least about 40 wt. %, or at least about 50 wt. %) and/or to at most about 75 wt. % (e.g., at most about 74 wt. %, at most about 73 wt. %, at most about 72 wt. %, at most about 71 wt. %, at most about 70 wt. %, at most about 60 wt. %, or at most about 55 wt. %), based on the total weight of the scale inhibitor composition.

The term “about,” as used in this disclosure, can allow for a degree of variability in a value or range, for example, within 10%, within 5%, or within 1% of a stated value or of a stated limit of a range.

In some embodiments, the scale inhibitor includes a phosphonate-based scale inhibitor, a polymer-based scale inhibitor, or a combination thereof. In some embodiments, the phosphonate-based scale inhibitor includes compounds that contain one or more of C—PO(OH)₂, C—PO(OH)(OR), or C—PO(OR)₂ groups, where R may be alkyl or aryl.

The “alkyl” in the phosphonate-based scale inhibitor may be a saturated straight or branched hydrocarbon having the number of carbon atoms indicated. For example, C₁₋₆ alkyl includes, but is not limited to, methyl, ethyl, propyl, isopropyl, butyl, isobutyl, sec-butyl, tert-butyl, pentyl, isopentyl, or hexyl.

The term “aryl” is art-recognized and refers to a carbocyclic aromatic group. Representative aryl groups include phenyl, naphthyl, anthracenyl, and the like. The “aryl” in the phosphonate-based scale inhibitor may include polycyclic ring systems having two or more carbocyclic rings in which two or more carbons are common to two adjoining rings (the rings are “fused rings”) wherein at least one of the rings is aromatic and, e.g., the other ring(s) may be cycloalkyls, cycloalkenyls, cycloalkynyls, and/or aryls. Unless specified otherwise, the aromatic ring may be substituted at one or more ring positions with, for example, halogen, azide, alkyl, aralkyl, alkenyl, alkynyl, cycloalkyl, hydroxyl, alkoxyl, amino, nitro, sulfhydryl, imino, amido, carboxylic acid, —C(O)alkyl, —CO₂alkyl, carbonyl, carboxyl, alkylthio, sulfonyl, sulfonamido, sulfonamide, ketone, aldehyde, ester, heterocyclyl, aryl or heteroaryl moieties, —CF₃, —CN, or the like. In certain embodiments, the aromatic ring is substituted at one or more ring positions with halogen, alkyl, hydroxyl, or alkoxyl. In certain other embodiments, the aromatic ring is not substituted, i.e., it is unsubstituted. In certain embodiments, the aryl group is a 6-10 membered ring structure.

In some embodiments, the phosphonate-based scale inhibitor includes, but is not limited to, amino trimethylene phosphonate (ATMP), bis-hexamethylene triamine-penta(methylene phosphonic) acid (BHPMP), diethylene triamine-penta(methylene phosphonic) acid (DETPMP), ethylene diamine tetramethylene phosphonate (EDTMP), nitrilo tris(methylene phosphonic) acid (NTMP), hydroxyethyl amino bis(methylene phosphonic) acid (HEBMP); 1-hydroxyethylidene-1,1-diphosphonic acid (HEDP), 2-phosphono-1,2,4-butanetricarboxylic acid (PBTC), polyamino polyether methylene phosphonate (PAPEMP), hexamethylene diamine-tetra(methylene phosphonic) acid (HDTMP); amineothylethanolamine phosphonate (AEEAP), or combinations thereof.

In some embodiments, the polymer-based scale inhibitor may include polyacrylates, polyphosphinocarboxylates, polymaleates, polyvinyl sulphonates, polyacrylamides, or combinations thereof. For example, suitable polymer-based scale inhibitors may include, but are not limited to, phosphino-polycarboxylic acid (PPCA), N-phosphonomethylated amino-2-hydroxypropylene polymer (PMPA), polyamino polyether methylene phosphonic acid (PAPEMP), polyvinyl sulfonate (PVS), sulfonated polycarboxylate (SPCA), acrylamido(methyl)propylsulfonic acid (AMPS), poly(allyloxy-2-hydroxyproply sulfonic acid), poly(styrene sulfonic acid) (SSA), poly(maleic anhydride) (MA), and poly(vinyl sulfonic acid) (VSA), or combinations thereof.

In some embodiments, the scale inhibitor is present in the scale inhibitor composition in an amount from about 25 wt. % to about 75 wt. %, based on the total weight of the scale inhibitor composition. In some embodiments, the scale inhibitor is present in the scale inhibitor composition in an amount of at least about 25 wt. % (e.g., at least about 26 wt. %, at least about 27 wt. %, at least about 28 wt. %, at least about 29 wt. %, at least about 30 wt. %, at least about 35 wt. %, at least about 40 wt. %, at least about 45 wt. %, or at least about 50 wt. %) and/or to at most about 75 wt. % (e.g., at most about 74 wt. %, at most about 73 wt. %, at most about 72 wt. %, at most about 71 wt. %, at most about 70 wt. %, at most about 65 wt. %, at most about 60 wt. %, or at most about 55 wt. %), based on the total weight of the scale inhibitor composition.

In some embodiments, the additive includes an amino polycarboxylic acid. The term “amino polycarboxylic acid” as used herein may refer to a compound containing two or more carboxyl groups, carboxylate groups, or carboxylate salt groups and one or more nitrogen atoms. The term “carboxyl group” refers to a functional group in the additive that contains a carbon atom double bonded to an oxygen atom and single bonded to a hydroxyl group (—COOH). The term “carboxylate” refers to the conjugate base of a carboxyl group having an anion (—COO⁻). The term “carboxylate salt” refers to a salt formed by the deprotonation of a carboxyl group, meaning the acidic hydrogen from the carboxyl group is replaced with a positively charged metal ion (M) to form the ionic compound (M(—COO)ₙ), where n is any integer that matches the positive charge of the metal ion (M). The metal ion (M) may be any metal ion. Non-limiting examples of the metal ion include sodium, potassium, calcium, magnesium, barium, or strontium.

In some embodiments, the amino polycarboxylic acid includes from two to eight carboxyl groups, carboxylate groups, or carboxylate salt groups. In some embodiments, the amino polycarboxylic acid includes at least two carboxyl groups, carboxylate groups, or carboxylate salt groups (e.g., at least three, at least four) and/or to at most eight (e.g., at most seven, at most six, or at most five). In some embodiments, the amino polycarboxylic acid includes one to six nitrogen atoms. In some embodiments, the amino polycarboxylic acid includes at least one nitrogen atom (e.g., at least two, or at least three) and/or at most six nitrogen atoms (e.g., at most five, or at most four). In some embodiments, the amino polycarboxylic acid includes zero to three hydroxyl groups (—OH). In some embodiments, the amino polycarboxylic acid includes at least one hydroxyl group and/or at most three hydroxyl groups (e.g., at most two). In some embodiments, the amino polycarboxylic acid includes five to 30 carbon atoms. In some embodiments, the amino polycarboxylic acid includes at least five carbon atoms (e.g., at least six, at least seven, at least eight, at least nine, or at least ten) and/or to at most 30 carbon atoms (e.g., at most 25, at most 20, or at most 15).

In some embodiments, the amino polycarboxylic acid has a structure according to the following formula (I):

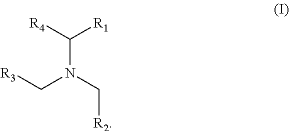

In some embodiments, R₁ is a carboxyl, a carboxylate, a carboxylate salt, or a C₁₋₅ alkylhydroxy. As used herein, “alkylhydroxy” may refer to a saturated straight or branched hydrocarbon having the number of carbon atoms indicated, where at least one of the hydrogen atoms is replaced with a hydroxy group. Exemplary C₁₋₅ alkylhydroxy may include, but are not limited to, methyl-hydroxy, ethyl-hydroxy, propyl-hydroxy, butyl-hydroxy, or pentyl-hydroxy.

In some embodiments, R₂ is a carboxyl, a carboxylate, or a carboxylate salt.

In some embodiments, R₃ is a carboxyl, a carboxylate, a carboxylate salt, a C₁₋₁₂ alkylcarboxyl, a C₁₋₁₂ alkylcarboxylate, a C₁₋₁₂ alkylcarboxylate salt, a (C₁₋₁₂ alkylamine)carboxyl, a (C₁₋₁₂ alkylamine)carboxylate, or a (C₁₋₁₂ alkylamine)carboxylate salt. In some embodiments, R₃ is a C₁₋₆ alkylcarboxyl, a C₁₋₆ alkylcarboxylate, a C₁₋₆ alkylcarboxylate salt, a (C₁₋₆ alkylamine)carboxyl, a (C₁₋₆ alkylamine)carboxylate, or a (C₁₋₆ alkylamine)carboxylate salt.

In some embodiments, R₄ is C₁₋₅ alkyl or hydrogen. As used herein, “alkyl” may refer to a saturated straight or branched hydrocarbon having the number of carbon atoms indicated.

As used herein, “alkylcarboxyl” may refer to a saturated straight or branched hydrocarbon having the number of carbon atoms indicated, where at least one of the hydrogen atoms is replaced with a carboxyl group. As used herein, “alkylcarboxylate” may refer to a saturated straight or branched hydrocarbon having the number of carbon atoms indicated, where at least one of the hydrogen atoms is replaced with a carboxylate group. As used herein, “alkylcarboxylate salt” may refer to a saturated straight or branched hydrocarbon having the number of carbon atoms indicated, where at least one of the hydrogen atoms is replaced with a carboxylate salt group.

As used herein, “(C₁₋₁₂ alkylamine)carboxyl” may refer to a saturated straight or branched hydrocarbon having the number of carbon atoms indicated, where at least one of the carbon atoms is attached to a nitrogen atom, and where at least one of the hydrogen atoms attached to the carbon atoms is replaced with a carboxyl group. As used herein, “(C₁₋₁₂ alkylamine)carboxylate” may refer to a saturated straight or branched hydrocarbon having the number of carbon atoms indicated, where at least one of the carbon atoms is attached a nitrogen atom, and where at least one of the hydrogen atoms attached to the carbon atoms is replaced with a carboxylate group. As used herein, “(C₁₋₁₂ alkylamine)carboxylate salt” may refer to a saturated straight or branched hydrocarbon having the number of carbon atoms indicated, where at least one of the carbon atoms is attached a nitrogen atom, and where at least one of the hydrogen atoms attached to the carbon atoms is replaced with a carboxylate salt group.

In some embodiments, the amino polycarboxylic acid includes one or more of:

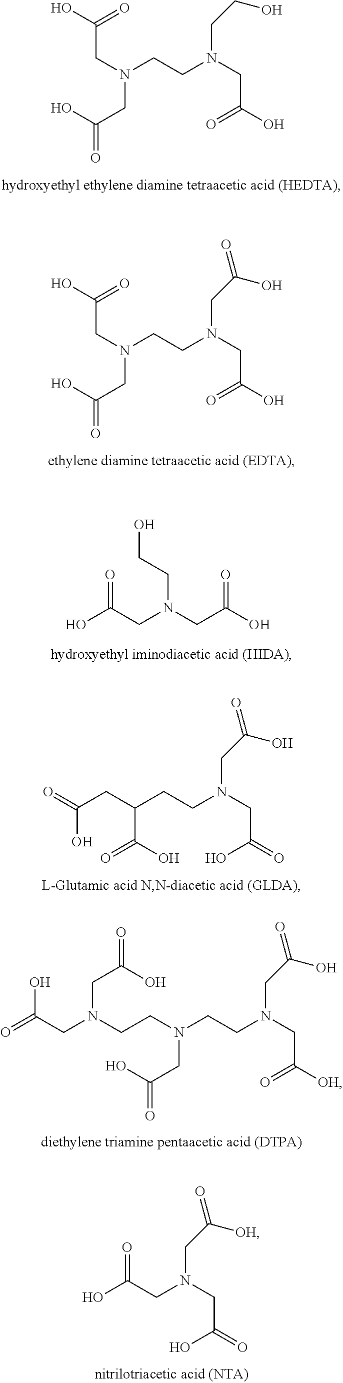 [SMILES: O=C(O)CN(CCO)CCN(CC(=O)O)CC(=O)O ; O=C(O)CN(CCN(CC(=O)O)CC(=O)O)CC(=O)O ; O=C(O)CN(CCO)CC(=O)O ; O=C(O)CC(CCN(CC(=O)O)CC(=O)O)C(=O)O ; O=C(O)CN(CCN(CC(=O)O)CC(=O)O)CCN(CC(=O)O)CC(=O)O ; O=C(O)CN(CC(=O)O)CC(=O)O]

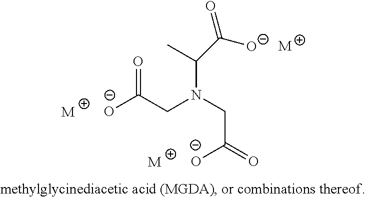

In some embodiments, a total weight ratio of the scale inhibitor to the additive (i.e., scale inhibitor:additive) is at least about 5:1. In some embodiments, a total weight ratio of the scale inhibitor to the additive is at least about 5:1 (e.g., at least about 10:1, at least about 15:1, at least about 20:1, at least about 25:1, at least about 30:1) and/or at most about 75:1 (e.g., at most about 70:1, at most about 60:1, at most about 50:1, or at most about 40:1). In some embodiments, the additive is free of phosphorous atoms, ether groups, or a combination thereof. In some embodiments, the scale inhibitor composition containing the scale inhibitor and the additive exhibits improved scale deposit removal compared to the same composition without the additive.

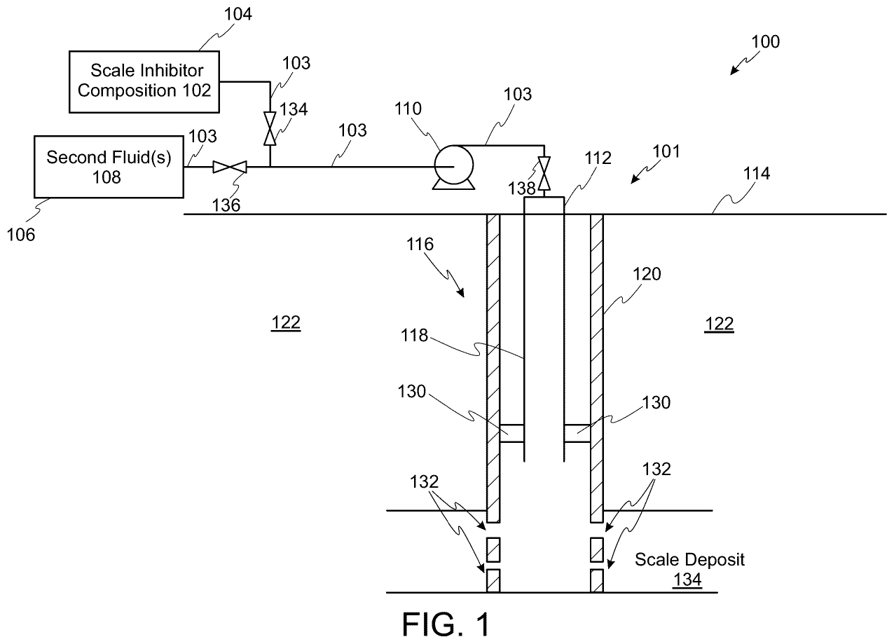

Referring to FIG. 1, a system 100 is shown that can deliver the scale inhibitor composition 102 to the subterranean formation 122 at a wellsite 101. In some embodiments, the system 100 includes a scale inhibitor source 104 (e.g., a vessel) that comprises the scale inhibitor composition 102. In some embodiments, the system 100 may include second fluid source 106 that comprises a second fluid 108, which may include, but is not limited to, water, enhance oil recovery (EOR) fluids, or scale inhibitor squeeze fluids. The system 100 may include a wellbore 116 that is formed through a surface 114 of the Earth into the subterranean formation 122. The subterranean formation 122 may include an oil reservoir comprising crude oil.

In some embodiments, the wellbore 116 includes a wellbore wall 120 that has been drilled to penetrate a portion of the subterranean formation 122, which may be formed out of one or more casing strings disposed therein. The casting strings of the wellbore wall 120 may be a series of connected pipes that are lowered into the wellbore 116 and cemented in place to form the wellbore 116 within the subterranean formation 122. Production tubing 118 may be disposed in the wellbore 116. In some embodiments, a wellbore head 112 is constructed at an entrance to the wellbore 116. The production tubing 118 may be coupled to the wellbore head 112 and configured to extend from the wellbore head 112 to a depth within the wellbore 116. The production tubing 118 may be held in place within the wellbore 116 by one or more packers 130. For example, the packer(s) 130 may be positioned between the wellbore wall 120 and the production tubing 118 to hold the production tubing 118 in place within the wellbore 116. The wellbore wall 120 may include one or more perforations 132 that provide fluid communication between crude oil reserves within the subterranean formation 122 and the wellbore 116. Scale deposits 134 can be deposited anywhere within the wellsite 101. For example, the scale deposits 134 may be deposited along the flow path near the wellbore 116, production tubing 112, and an inner surface of the subterranean formation 122.

The system 100 may include a pump 110 that is configured to transfer the scale inhibitor composition 102 from the scale inhibitor source 104 to the wellbore 116. The pump 110 may also be configured to transfer the second fluid 108 from the second fluid source 106 to the wellbore 116. A conduit 103 may place the scale inhibitor source 104, the second fluid source 106, the pump 110, and the wellbore 116 in fluid communication. The system 100 may include a first valve 134 positioned between the scale inhibitor source 104 and the wellbore 116. The first valve 134 may be moveable between an open position that is configured to allow fluid to flow through the first valve 134 to the wellbore 116 and a closed position that is configured to mitigate, or otherwise prevent, the flow of fluid to pass through the first valve 134 to the wellbore 116.

The system 100 may include a second valve 136 positioned between the second fluid source 108 and the wellbore. The second valve 136 may be moveable between an open position that is configured to allow fluid to flow through the second valve 136 to the wellbore 116 and a closed position that is configured to mitigate, or otherwise prevent, the flow of fluid to pass through the second valve 136 to the wellbore 116. The system 100 may include a wellbore valve 138 positioned between the pump 110 and the wellbore 116 to regulate the flow of fluids from the pump 110 to the wellbore 116. The wellbore valve 138 maybe moveable between an open position that is configured to allow fluid to flow through the wellbore valve 138 to the wellbore 116 and a closed position that is configured to mitigate, or otherwise prevent, the flow of fluid to pass through the wellbore valve 138 to the wellbore 116.

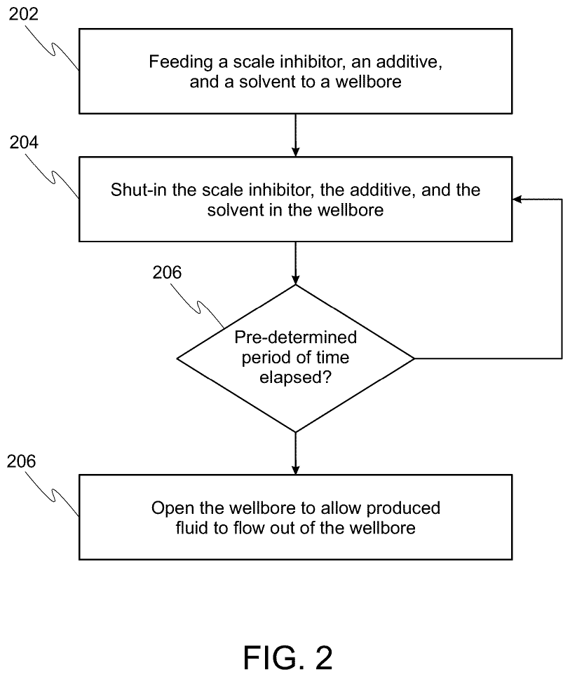

Referring to FIG. 2, an example method 200 for treating scale deposits 134 at a wellsite 101 is shown according to some embodiments of the present disclosure. The method 200 may begin at operation 202, which may include feeding the scale inhibitor, the additive including an amino polycarboxylic acid, and the solvent to the wellbore 116 to contact a scale deposit 134. For example, operation 202 may include feeding the scale inhibitor composition 102 from the scale inhibitor source 104, through conduit 103, and to the wellbore 116 using the pump 110. Operation 202 may include opening the first valve 134 and the wellbore valve 138 to allow the delivery of the scale inhibitor composition 102 to the wellbore 116. In some embodiments, operation 202 may deliver the scale inhibitor composition 102 the wellbore 116 during a scale inhibitor squeeze treatment, via continuous or intermittent injection with a second fluid 108, or by direct delivery of the scale inhibitor composition 102 without the second fluid 108.

For example, during the scale inhibitor squeeze treatment, the second fluid source 106 may include scale inhibitor squeeze fluids (e.g., pre-flush fluid and an over flush fluid), where operation 202 may include first delivering a pre-flush fluid from the second fluid source 106 to the wellbore 116, delivering the scale inhibitor composition 102 following the pre-flush fluid, and delivering an overflush fluid from the second fluid source 106 following the scale inhibitor composition 102. The pre-flush fluid may include, but is not limited to, water, brine, seawater, mutual solvents, or a combination thereof. In some embodiments, the overflush may include, but is not limited to, water, brine, or produced water. During the scale inhibitor squeeze treatment, the pre-flush fluid may be delivered to the wellbore 116 via the pump 110 by opening the second valve 136 and the wellbore valve 138 while the first valve 134 is closed. Following delivery of the pre-flush fluid, the second valve 136 may be closed and the first valve 134 may be opened to deliver the scale inhibitor composition 102. Following delivery of the scale inhibitor composition 102, valve 134 may be closed and the second vale 136 may be opened to deliver the overflush fluid to drive the scale inhibitor composition 102 and the pre-flush fluid through the wellbore 116.

In some embodiments, rather than performing a scale inhibitor squeeze treatment, the scale inhibitor composition 102 may delivered to the wellbore 116 intermittently or continuously with a second fluid 108. For example, operation 202 may first include delivering a second fluid 108 to the wellbore 116. The second fluid 108 may be water or EOR fluids, which are being pumped to the wellbore 116 to increase reservoir pressure, displace crude oil, or to maintain production levels. Operation 202 may include intermittently or continuously mixing the scale inhibitor composition 102 with the second fluid 108 prior to delivery to the wellbore 116. For example, the first valve 134 may be regulated to deliver the desired dosage, or otherwise opened and closed to intermittently to deliver the scale inhibitor composition 102 to the wellbore 116. In some embodiments, the scale inhibitor composition 102 is delivered to the wellbore 116 without a second fluid 108. In some embodiments, mixing the scale inhibitor composition with the second fluid 108 dilutes a concentration of the scale inhibitor such that the dosage of the scale inhibitor in the wellbore 116 and/or in the subterranean formation 122 is from 5 ppm to 50 ppm. In some embodiments, during operation 202, the dosage of the scale inhibitor in the wellbore and/or in the subterranean formation 122 is at least about 5 ppm (e.g., at least about 6 ppm, at least about 7 ppm, at least about 8 ppm, at least about 9 ppm, at least about 10 ppm, at least about 15 ppm) and/or at most about 50 ppm (e.g., at most 40 ppm, at most 30 ppm, at most 20 ppm, at most 15 ppm). In some embodiments, the synergistic effects between the scale inhibitor and the additive increase scale inhibitor efficacy such that lower dosages of scale inhibitor may be used, e.g., from 5 ppm to 10 ppm, to achieve the same results as compared to a scale inhibitor alone (i.e., without the additive) at a higher dosage from 20-50 ppm.

In some embodiments, the method 200 at operation 204 includes shutting-in the scale inhibitor, the additive, and the solvent within the wellbore 116 and the subterranean formation 120 for a pre-determined period of time. In some embodiments, operation 204 includes closing the wellbore valve 138 to shut-in the scale inhibitor composition 102. Shutting-in the scale inhibitor composition 102 may increase contact time between the scale inhibitor composition 102 and the scale deposits 134 to improve scale inhibitor performance. In some embodiments, the pre-determined period of time is at least 1 minute, at least 30 minutes, at least 1 hour, at least 6 hours, at least 12 hours, to less than 24 hours, less than 30 hours, less than 36 hours, less than 42 hours, or less than 48 hours.

At decision block 206, the method includes determining whether the pre-determined period of time has elapsed. If the pre-determined period of time has not elapsed, the method 200 returns to operation 204. If the pre-determined period of time has elapsed, the method 200 proceeds to operation 208. At operation 208, the method 200 includes opening the wellbore valve 138 to allow produced fluid in the subterranean formation 120 to flow out of the wellbore 116.

The present disclosure is illustrated in more detail with reference to the following example, which is for illustrative purposes and should not be construed as limiting the scope of the present disclosure.

### EXAMPLE

### Example 1

The enhancement effect of hydroxyethyl ethylenediamine triacetic acid (HEDTA) in combination with a scale inhibitor was tested by a series of scale inhibition tests. Test water included a mixture of 50% produced water from a sweet gas reservoir and 50% produced water from sour gas reservoir, as listed in Table 1.

TABLE 1
Produced water compositions

| | |
|---|---|
| | Produced water |
| Parameter | from gas reservoir |

| (mg/L) | Sweet | Sour |
|---|---|---|
| Sodium | 6,150 | 12,605 |
| Potassium | 665 | 377 |
| Calcium | 5,600 | 880 |
| Magnesium | 795 | 512 |
| Barium | 382 | 0 |
| Strontium | 315 | 12 |
| Alkalinity | 125 | 110 |
| Sulfate | 0 | 1,050 |
| Chloride | 22,800 | 21,998 |
| TDS | 36,840 | 37,555 |

The composition is summarized in Table 2. Synthetic brines were prepared based on the composition. The brine was separated into anion and cation solutions in order to avoid any scale formation during preparation (see Table 2). Cation brine contains chloride salts of calcium, magnesium, strontium and potassium, anion brines contain sodium salts of bicarbonate and sulfate; while sodium chloride salt is divided equally. For anion solutions, sodium bicarbonate was added just before starting the test to minimize the loss of dissolved carbon dioxide CO₂. After that, the prepared solutions i.e. anion and cation were filtered with 0.45 μm to remove suspended solids. A mixture of equal volumes of cation and anion solutions resulted in the desired test water composition (Table 2).

TABLE 2
Test water composition

| | |
|---|---|
| Sodium (mg/L) | 9378 |
| Potassium (mg/L) | 521 |
| Calcium (mg/L) | 3240 |
| Magnesium (mg/L) | 654 |
| Barium (mg/L) | 191 |
| Strontium (mg/L) | 164 |
| Bicarbonate (mg/L) | 68 |
| Sulfate (mg/L) | 525 |
| Chloride (mg/L) | 22399 |
| pH | 6.0 |

The first set of tests was conducted using the conventional bottle test method. Samples were prepared at ambient condition and then placed in a preheated oven (150° F.). Samples were removed out of oven for visual inspection of scale formation after 2 and 4 hours. Two scale inhibitors (polymer-based inhibitor, such as polyacrylate-based KT-333 from ChampionX and phosphonate-based MC MX2-5318 from Halliburton) without and with 1 ppm HEDTA. Test results are summarized in Table 3 for MC MX 2-5831 and Table 4 for KT-333. Both sets of samples showed that HEDTA can surprisingly and unexpectedly enhance the inhibition efficacy of inhibitor products against barite scale formation.

TABLE 3
Bottle test results with phosphonate-
based inhibitor MC MX 2-5831

| | |
|---|---|
| After | |
| 2 hours | MC MX 2-5831 |

| HEDTA | 5 | 10 | 15 | 20 |
|---|---|---|---|---|
| none | Precipitate | Precipitate | Clear | Clear |
| 1 ppm | Clear | Clear | Clear | Clear |

| | |
|---|---|
| After | |
| 4 hours | MC MX 2-5831 |

| HEDTA | 5 | 10 | 15 | 20 |
|---|---|---|---|---|
| none | Precipitate | Precipitate | Precipitate | Clear |
| 1 ppm | Precipitate | Clear | Clear | Clear |

For the phosphonate-based scale inhibitor, after 2 hours of test duration, scale precipitate was noted in samples with 5 and 10 ppm of inhibitor but without additive HEDTA, but not in these samples when 1 ppm HEDTA added. Similarly, after 4 hours of test duration, scale precipitate was noted in 10 ppm and 15 ppm inhibitor samples without HEDTA but not with 1 ppm HEDTA.

TABLE 4
Bottle test results with polymer-based inhibitor KT-333

| | |
|---|---|
| After | |
| 2 hours | KT-333 |

| HEDTA | 5 | 10 | 15 | 20 |
|---|---|---|---|---|
| none | Precipitate | Precipitate | Clear | Clear |
| 1 ppm | Precipitate | Clear | Clear | Clear |

| | |
|---|---|
| After | |
| 4 hours | KT-333 |

| HEDTA | 5 | 10 | 15 | 20 |
|---|---|---|---|---|
| none | Precipitate | Precipitate | Precipitate | Clear |
| 1 ppm | Precipitate | Clear | Clear | Clear |

For the polymer-based scale inhibitor, after 2 hours of test duration, the 10 ppm inhibitor samples had scale precipitate formed without additive HEDTA but free of scale precipitate with 1 ppm HEDTA. After 4 hours of test duration, the sample with 15 ppm KT-333 but without HEDTA showed scale formation; however, no scale formed with HEDTA even at the sample with less inhibitor (10 ppm).

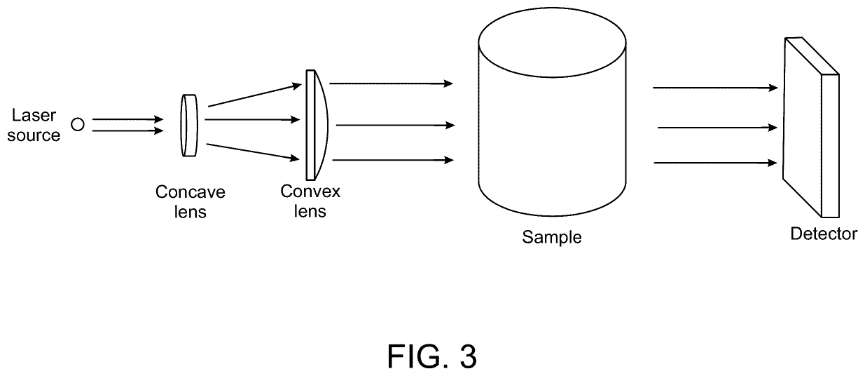

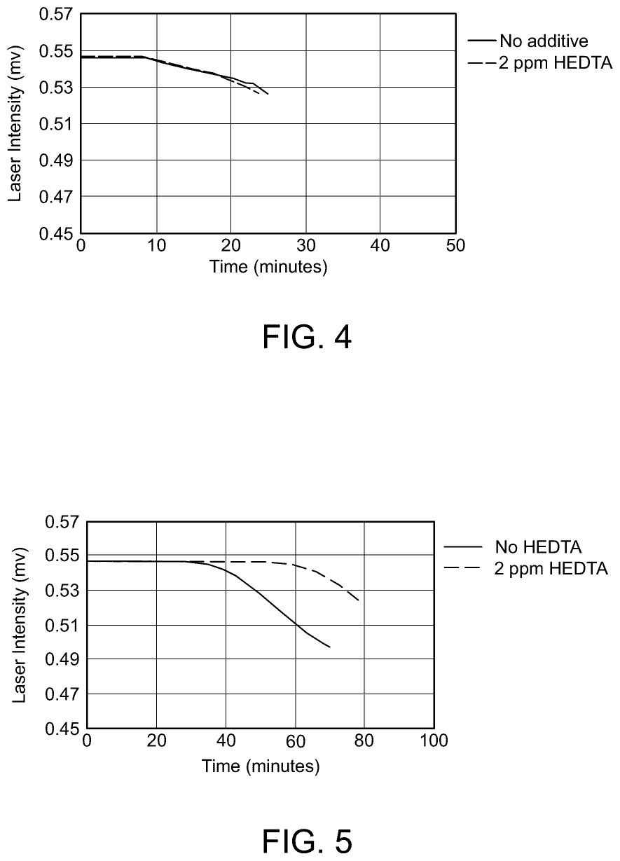

Further tests were conducted using a laser apparatus to measure the change of turbidity of scaling waters (FIG. 3). The apparatus can detect the barite scale formation in-situ by monitoring the change of laser intensity received on detector. The laser source was stable. Once barite scale occurred, laser light was scattered and by scale particles, which causes the decease of the intensity of laser reached the detector. A multimeter is used to continuously measure the laser intensity on detector and the reading is recorded every 5 seconds. Tests were conducted at 25° C. (77° F.). FIG. 4 shows two laser turbidity tests. In the “no additive” test, no additive or scale inhibitor were added. In the “2 ppm HEDTA” test, 2 ppm of an additive was added. As shown in FIG. 4, barite scale formed quickly in the absence of scale inhibitor, regardless of HEDTA. FIG. 5 shows two laser turbidity tests. In the “no HEDTA” test, 10 ppm of the phosphonate-based scale inhibitor was added without the additive. In the “2 ppm HEDTA” test, 10 ppm of the phosphonate-based scale inhibitor was added with 2 ppm of the additive.

These results show that adding an amino polycarboxylic acid to the scale inhibitor can surprisingly and unexpectedly improve scale inhibitor performance against scales, such as barite. The phosphorus free additive is lower in cost and has a lower environmental impact when compared to scale inhibitors. Thus, by formulating the scale inhibitor composition with the additive and the scale inhibitor synergistic effects are achieved to improve scale treatment efficiency, improve treatment reliability, and reduce treatment cost.

While the invention has been described in detail with reference to certain embodiments thereof, it will be understood that modifications and variations are within the spirit and scope of that which is described and claimed.

1. A method comprising:
feeding a scale inhibitor composition to a wellbore positioned in a portion of a subterranean formation to contact a scale deposit comprising a sulfate scale, wherein the scale inhibitor composition comprises:
a solvent;
a scale inhibitor in an amount from about 25 wt. % to about 75 wt. %, based on a total weight of the scale inhibitor composition, wherein the scale inhibitor comprises a polymer-based scale inhibitor selected from the group consisting of a polyacrylate, a polyphosphinocarboxylate, a polymaleate, a polyvinyl sulphonate, a polyacrylamide, and a combination thereof; and
an additive in an amount from about 0.1 wt. % to about 10 wt. %, based on the total weight of the scale inhibitor composition, wherein the additive comprises an amino polycarboxylic acid.

2. The method of claim 1, wherein the additive has a structure according to the following formula (I): 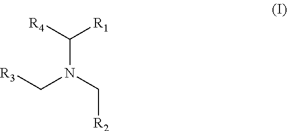
wherein R₁ is a carboxyl, a carboxylate, a carboxylate salt, or a C₁₋₅ alkylhydroxy;
wherein R₂ is a carboxyl, a carboxylate, or a carboxylate salt;
wherein R₃ is a carboxyl, a carboxylate, a carboxylate salt, a C₁₋₁₂ alkylcarboxyl, a C₁₋₁₂ alkylcarboxylate, a C₁₋₁₂ alkylcarboxylate salt, a (C₁₋₁₂ alkylamine)carboxyl, a (C₁₋₁₂ alkylamine)carboxylate, or a (C₁₋₁₂ alkylamine)carboxylate salt; and
wherein R₄ is C₁₋₅ alkyl or hydrogen.

3. The method of claim 1, wherein the amino polycarboxylic acid comprises:
from two to six carboxyl groups, carboxylate groups, or carboxylate salt groups;
from one to four nitrogen atoms;
from zero to three hydroxyl groups; and
from five to 30 carbon atoms.

4. The method of claim 1, wherein the solvent comprises water, an organic solvent, or a mixture thereof.

5. The method of claim 4, wherein the organic solvent is selected from the group consisting of methanol, acetone, monoethylene glycol, triethylene glycol, and a combination thereof.

6. (canceled)

7. (canceled)

8. The method of claim 1, wherein the polymer-based scale inhibitor is selected from the group consisting of phosphino-polycarboxylic acid (PPCA), N-phosphonomethylated amino-2-hydroxypropylene polymer (PMPA), polyamino polyether methylene phosphonic acid (PAPEMP), polyvinyl sulfonate (PVS), sulfonated polycarboxylate (SPCA), acrylamido(methyl)propylsulfonic acid (AMPS), allyloxy-2-hydroxyproply sulfonic acid, styrene sulfonic acid (SSA), maleic anhydride (MA), and vinyl sulfonic acid (VSA), and combinations thereof.

9. The method of claim 1, wherein a total weight ratio of the scale inhibitor to the additive is at least about 5:1.

10. The method of claim 1, wherein the additive is free of phosphorous atoms, ether groups, or a combination thereof.

11. The method of claim 2, wherein R₃ is a C₁₋₆ alkylcarboxyl, a C₁₋₆ alkylcarboxylate, a C₁₋₆ alkylcarboxylate salt, a (C₁₋₆ alkylamine)carboxyl, a (C₁₋₆ alkylamine)carboxylate, or a (C₁₋₆ alkylamine)carboxylate salt.

12. The method of claim 1, wherein the scale inhibitor composition exhibits improved scale deposit removal compared to the same composition without the additive.

13. The method of claim 1, wherein the additive is selected from the group consisting of: 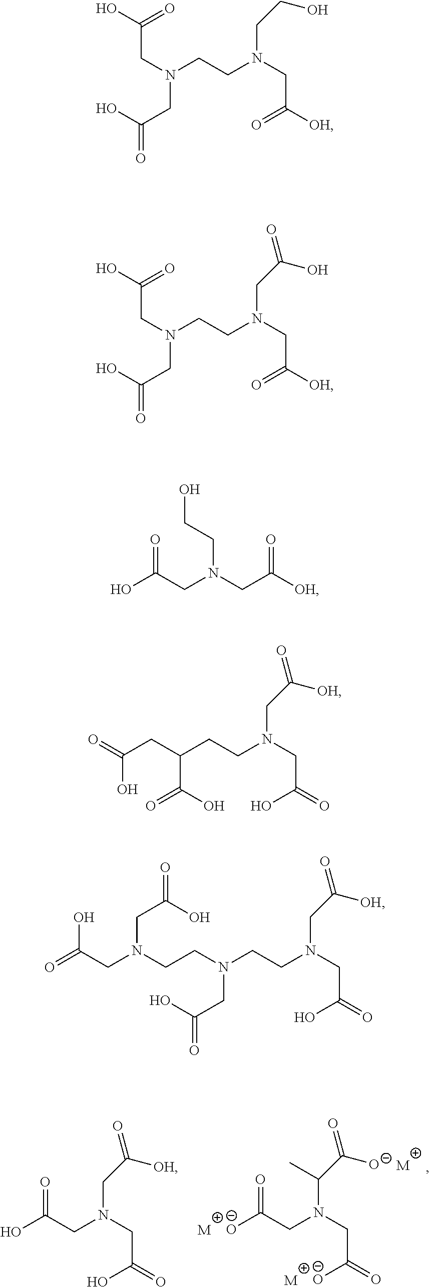
and combinations thereof.

15.-28. (canceled)

29. The method of claim 1, wherein feeding the scale inhibitor composition to the wellbore further includes diluting the scale inhibitor composition with a second fluid such that a dosage of the scale inhibitor is from about 5 ppm to 50 ppm in the wellbore.

30. A method comprising:
feeding a scale inhibitor and an additive comprising an amino polycarboxylic acid to a wellbore positioned in a portion of a subterranean formation to contact a scale deposit comprising a sulfate scale;
wherein a total weight ratio of the scale inhibitor to the additive fed to the wellbore is at least 5:1 to at most 75:1; and
wherein the scale inhibitor comprises a polymer-based scale inhibitor selected from the group consisting of a polyacrylate, a polyphosphinocarboxylate, a polymaleate, a polyvinyl sulphonate, a polyacrylamide, or a combination thereof.
